(19) United States
(12) Patent Application Publication
(10) Pub. No.: US 2014/0082467 A1
(43) Pub. Date: Mar. 20, 2014

(54) METHOD FOR CONTENT COORDINATION, AND SYSTEM, APPARATUS AND TERMINAL SUPPORTING THE SAME

(71) Applicant: Samsung Electronics Co., Ltd., Suwon-si (KR)

(72) Inventors: Sungjin YOON, Suwon-si (KR); Jinha JUN, Seoul (KR)

(73) Assignee: Samsung Electronics Co., Ltd., Suwon-si (KR)

(21) Appl. No.: 14/026,743

(22) Filed: Sep. 13, 2013

(30) Foreign Application Priority Data
Sep. 14, 2012 (KR) 10-2012-0101958

(51) Int. Cl. G06F 17/21

(52) U.S. Cl. CPC G06F 17/212
USPC 715/202

(57) ABSTRACT

A method for content coordination, and a system, apparatus and terminal supporting the same are provided. The content coordination system may include a first terminal obtaining information on a specific page of a content providing object and sending information on the content providing object and the page information thereof, a cloud service apparatus generating content reading information for second content, which is the same in payload as the content providing object but is different in a reading mode therefrom, using the information on the content providing object and the page information thereof, and a second terminal supporting content playback, and playing back, in response to a playback request for the second content, the second content from a page indicated by the content reading information.

### PRIORITY

This application claims the benefit under 35 U.S.C. §119(a) of a Korean patent application filed on Sep. 14, 2012 in the Korean Intellectual Property Office and assigned Serial No.10-2012-0101958, the entire disclosure of which is hereby incorporated by reference.

### TECHNICAL FIELD

The present disclosure relates to coordinated management of content. More particularly, the present disclosure relates to a method for content coordination, and a system, apparatus and terminal supporting the same that coordinate playback of pieces of content that are the same in payload but different in a reading mode to thereby adaptively indicate the reading place of a user in the content.

### BACKGROUND

Mobile terminals supporting communication have entered into widespread use due to small sizes thereof enabling ease of portability. Recently, increased touchscreen sizes, advanced hardware and software support and diversified digital content have dramatically accelerated popularization of mobile terminals.

Such a mobile terminal presents a variety of content through a display unit. Hence, a user may use content in an intuitive manner and manipulate content according to personal preferences. We live in a digital age, but there are still many persons using analog content. For example, numerous users purchase and read paper-printed newspapers, magazines and books. On this account, many content providers simultaneously produce analog content and digital content for distribution and sale. Hence, it is desirable to provide a new service that combines and coordinates analog content and digital content.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for content coordination, and a system, apparatus and terminal supporting the same that coordinate playback of pieces of content, which are the same in payload but different in a reading mode, so that content playback is started or resumed from a desired reading place.

In accordance with an aspect of the present disclosure, a system for content coordination is provided. The system includes a first terminal obtaining information on a specific page of a content providing object and sending information on the content providing object and the page information thereof, a cloud service apparatus generating content reading information for second content, which is the same in payload as the content providing object but is different in a reading mode therefrom, using the information on the content providing object and the page information thereof, and a second terminal supporting content playback, and playing back, in response to a playback request for the second content, the second content from a page indicated by the content reading information.

In accordance with another aspect of the present disclosure, a service apparatus supporting content coordination is provided. The service apparatus includes a communication unit receiving first content reading information containing information on a content providing object and information on a page thereof, and receiving second content reading information containing information on second content, which is the same in payload as the content providing object but is different in a reading or a playback mode therefrom, and information on a last playback page thereof, and a control unit controlling a process of sending the first content reading information to a second terminal playing back the second content and sending the information on the second content to a first terminal obtaining information on a page of the content providing object.

In accordance with another aspect of the present disclosure, a terminal supporting content coordination is provided. The terminal includes an information collector obtaining information on a content providing object and information on a page thereof, a control unit controlling a process of generating first content reading information containing information on the content providing object and information on a page thereof, and sending the first content reading information to a cloud service apparatus, and a communication unit supporting transmission of the first content reading information.

In accordance with another aspect of the present disclosure, a terminal supporting content coordination is provided. The terminal includes a display unit outputting a screen for playback of an e-book, a communication unit receiving, in response to a playback request for the e-book, content reading information of first content, which is the same in payload as the e-book but is different in a reading mode therefrom, from a different terminal, and a control unit controlling an operation to play back the e-book from a page indicated by page information contained in the content reading information.

In accordance with another aspect of the present disclosure, a method for content coordination is provided. The method includes receiving, by a terminal, a reading request for a content providing object that is a paper book, receiving, by the terminal, information on a last playback page of second content, which is the same in payload as the content providing object but is different in a reading mode therefrom, from a service apparatus, and outputting, by the terminal, the information on the last playback page.

In accordance with another aspect of the present disclosure, a method for content coordination is provided. The method includes placing an electronic bookmark at a page of a content providing object, obtaining, upon page closing in the content providing object, by the electronic bookmark, page information of the content providing object by recognizing a marker placed thereat, sending, by the electronic bookmark, the page information directly or through a terminal to a cloud service apparatus, and sending, when a different terminal requests playback of second content which is the same in payload as the content providing object but is different in a reading mode therefrom, the page information of the content providing object to the different terminal.

In accordance with another aspect of the present disclosure, a method for content coordination is provided. The method includes receiving, by a terminal, a playback request for an e-book, receiving, by the terminal, page information of a content providing object, which is the same in payload as the e-book but is different in a reading mode therefrom, from a service apparatus, and outputting, by the terminal, information on a playback page of the e-book on the basis of the page information.

In a feature of the present disclosure, the method for content coordination, and the system, apparatus and terminal supporting the same enable synchronization between analog content and digital content. Thanks to such synchronization, the playback position of the digital content may be more adaptively determined, and information obtained from reading of the digital content may be utilized when reading the analog content.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a content coordination system according to an embodiment of the present disclosure;

FIG. 2 is a block diagram of a first terminal in the system of FIG. 1 according to an embodiment of the present disclosure;

FIG. 3 is a block diagram of a second terminal in the system of FIG. 1 according to an embodiment of the present disclosure;

FIG. 4 is a block diagram of a cloud service apparatus in the system of FIG. 1 according to an embodiment of the present disclosure;

FIG. 5 is a sequence diagram illustrating a content coordination method according to a first embodiment of the present disclosure;

FIG. 6 is a sequence diagram illustrating a content coordination method according to a second embodiment of the present disclosure;

FIG. 7 is screen representations illustrating content coordination according to an embodiment of the present disclosure;

FIG. 8 illustrates a system coordinating paper-book content and e-book content using an electronic bookmark according to another embodiment of the present disclosure; and

FIG. 9 is a block diagram of the electronic bookmark in the system of FIG. 8 according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

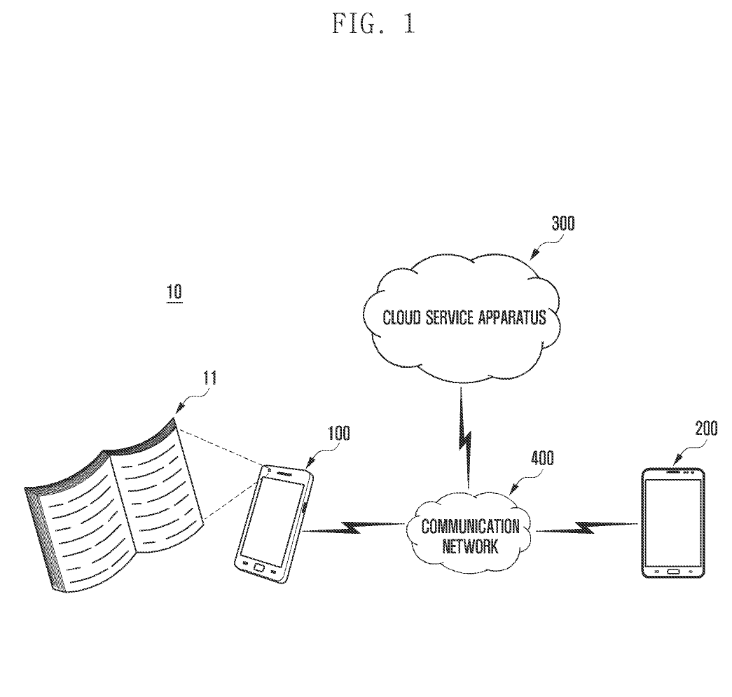

FIG. 1 illustrates a content coordination system according to an embodiment of the present disclosure.

Referring to FIG. 1, the content coordination system 10 includes a first content providing object 11, a first terminal 100, a second terminal 200 and a cloud service apparatus 300, and may further include a communication network 400 to exchange signals between the above entities.

In the content coordination system 10 having the above configuration of the present disclosure, the first terminal 100 collects information regarding the first content providing object 11 and a reading place of the user in the first content providing object 11, generates first content reading information using the collected information, and sends the first content reading information to the cloud service apparatus 300. When the second terminal 200 plays back second content, which is the same in payload as the first content providing object 11 but is different in a reading mode therefrom, the content coordination system 10 enables the second terminal 200 to automatically determine an initial playback position in the second content on the basis of the first content reading information. Hence, the user, who uses multiple terminals, may manipulate the second terminal 200 to play back the second content from a desired position according to reading information obtained from the first content providing object 11, thereby maintaining a reading place between pieces of content.

The first content providing object 11 may be an object without a communication capability on which the first content is written, printed, or output. For example, the first content providing object 11 may be a paper-printed document, newspaper, magazine or book containing specific information (i.e., first analog type content). The first content providing object 11 may be an electronic device capable of storing and displaying first content without a communication capability.

The first terminal 100 obtains information on the current reading place of the user in the first content providing object 11, generates first content reading information containing information on the current reading place and information on the first content providing object 11, and sends the first content reading information to the cloud service apparatus 300. According to a user request, the first terminal 100 may receive reading information for the second content, which is the same in payload as the first content providing object 11 but is different in a reading mode therefrom, from the cloud service apparatus 300 and display the second content reading information. For sharing and synchronization of content reading information, the first content reading information provided by the first terminal 100 to the cloud service apparatus 300 may include information on the first content providing object 11 such as publisher, title, book size and pages. Such first content reading information may be collected through various components of the first terminal 100. To this end, the first terminal 100 may be designed so as to be placed on the first content providing object 11. A detailed configuration of the first terminal 100 is described further below with reference to the drawings.

The second content may be digital content having the same payload as the first content providing object 11, such as an electronic newspaper, magazine, dissertation, document, or photo album composed of sections. The second content may be stored in a storage unit of the second terminal 200, and be activated and displayed on a display unit in response to a user request. For example, the second content may be an e-book or the like.

The second terminal 200 may connect to the cloud service apparatus 300 through the communication network 400 and receive content reading information for the second content from the cloud service apparatus 300. Thereafter, when playing back the second content, the second terminal 200 may automatically determine the initial playback position for the second content on the basis of the received content reading information and display the second content from the initial playback position. Here, the content reading information may contain information on a specific reading place in the first content. Hence, the second terminal 200 may play back the second content from a playback position corresponding to the last reading place in the first content.

Upon termination of playback of the second content, the second terminal 200 may obtain second content reading information related to the playback termination position in the second content and send the second content reading information to the cloud service apparatus 300. For sharing and synchronization of content reading information, similarly to the first content reading information, the second content reading information may include information on the second content such as publisher, title, book size and pages. For example, the second terminal 200 may be an e-book reader capable of playing back e-book content.

The cloud service apparatus 300 may receive first content reading information from the first terminal 100 and store the first content reading information in a form applicable to the second content. The cloud service apparatus 300 may receive second content reading information from the second terminal 200 and store the second content reading information in a form usable for reading of the first content. In response to a request for content reading information related to the first content from the first terminal 100, the cloud service apparatus 300 may send second content reading information generated using playback records of the second terminal 200 to the first terminal 100. In response to a request for content reading information from the second terminal 200, the cloud service apparatus 300 may send content reading information generated using first content reading information provided by the first terminal 100 to the second terminal 200. When first content reading information is received from the first terminal 100, the cloud service apparatus 300 may convert the first content reading information into content reading information applicable to the second content. For example, the cloud service apparatus 300 may search for an e-book, as the second content, matching the title and publisher of the first content indicated by the first content reading information and generate content reading information by obtaining a page number in the second content corresponding to a page number in the first content. As described before, the cloud service apparatus 300 may collect reading information for the first content and use the reading information to determine a playback position for playback of the second content.

The communication network 400 provides communication channels to exchange data between the constituents of the content coordination system 10. That is, the communication network 400 may establish a communication channel between the first terminal 100 and the cloud service apparatus 300 and establish a communication channel between the cloud service apparatus 300 and the second terminal 200. The communication network 400 enables the first terminal 100 and the second terminal 200 to receive content reading information from the cloud service apparatus 300 and to send first content reading information and second content reading information to the cloud service apparatus 300. To support data transmission, the communication network 400 may be realized using various communication technologies. For example, the communication network 400 may establish a communication channel between the first terminal 100 and the cloud service apparatus 300 based on wireless access points, Wi-Fi communication or wired Internet communication. The communication network 400 may establish a communication channel between the cloud service apparatus 300 and the second terminal 200 based on mobile communication. The communication network 400 may establish a communication channel between the first terminal 100, second terminal 200 and cloud service apparatus 300 based on wired communication. As described above, the communication network 400 interconnecting the first terminal 100, the second terminal 200 and the cloud service apparatus 300 may be realized using one or more of various data communication technologies, and is not limited to a particular network type.

As described above, the content coordination system 10 obtains information on the reading place in the first content providing object 11 through the first terminal 100, and applies the reading place information to playback of the second content on the second terminal 200 so that the user may read the second content from a desired reading place. In addition, when the user wishes to read the first content providing object 11, the content coordination system 10 enables the user to use second content reading information through the first terminal 100, so that the user may readily locate a desired reading place in the first content providing object 11. In other words, in the case where the user uses first content and second content having the same payload, when the user wishes to locate a desired reading place (such as a page) in one content, the content coordination system 10 reminds the user of the last reading place (such as a page) in the other content. Hence, the user does not have to spend time and effort to locate a page at which to start or resume reading content.

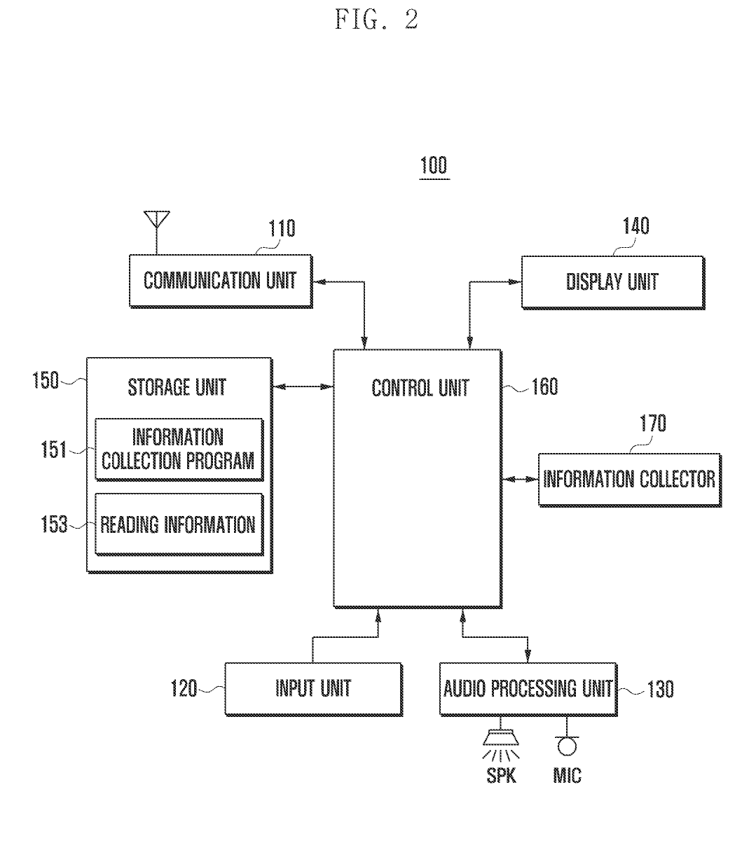

FIG. 2 is a block diagram of the first terminal according to an embodiment of the present disclosure.

Referring to FIG. 2, the first terminal 100 includes a communication unit 110, an input unit 120, an audio processing unit 130, a display unit 140, a storage unit 150, and a control unit 160, and may further include an information collector 170 to obtain reading information of the first content providing object 11.

The first terminal 100 having the above configuration may collect information on the first content providing object 11 and information on the reading place of the user therein, generate first content reading information using the collected information, and send the first content reading information to the cloud service apparatus 300. In response to a user request, the first terminal 100 may receive second content reading information related to the first content from the cloud service apparatus 300 and present the second content reading information to the user.

To this end, the communication unit 110 may be configured to establish a communication channel to the cloud service apparatus 300 through the communication network 400. The communication unit 110 may include one of various communication modules according to the design of the first terminal 100. For example, the communication unit 110 may include at least one of a wireless communication module, a wired communication module and a mobile communication module. To access the cloud service apparatus 300, the communication unit 110 may send user authentication information to the cloud service apparatus 300 and receive content reading information therefrom after successful authentication. When first content reading information is collected, the communication unit 110 may send the first content reading information to the cloud service apparatus 300.

The input unit 120 may be configured to generate various input signals used for operation and manipulation of the first terminal 100. The input unit 120 may have one of various configurations according to input generation schemes of the first terminal 100. For example, when the display unit 140 has a touchscreen capability, the input unit 120 may be realized by use of a display panel displaying a key map and a touch panel having a touch region on the display panel. The input unit 120 may include a key button, keypad, side key, and home key. The input unit 120 may be configured to include a pen touch panel supporting use of a touch pen.

The input unit 120 may generate a control signal for controlling the information collector 170 to identify the reading place in the first content providing object 11. For example, when the information collector 170 is composed of a camera module, the input unit 120 may generate a control signal to capture an image of a portion of the first content providing object 11. The input unit 120 may generate input signals for communication with the cloud service apparatus 300, such as sending a connection request to the cloud service apparatus 300, entering authentication information, and sending a request for content reading information related to the first content.

The audio processing unit 130 supports output of various audio data in the course of operating the first terminal 100. When the first terminal 100 supports call handling or recording, the audio processing unit 130 may include a microphone MIC to collect audio signals. The audio processing unit 130 may output sound notifications to guide a procedure for obtaining reading information from the first content providing object 11. When information related to the first content providing object 11 is collected, the audio processing unit 130 may output the collected information including the title of the first content, publisher and current reading place or page as a sound notification. Output of sound notifications may be disabled according to user settings.

The display unit 140 may display a variety of screens used for operation of the first terminal 100. For example, the display unit 140 may output a screen for displaying reading information of the first content providing object 11. That is, when reading information related to the first content providing object 11 is collected according to a request, the display unit 140 may output the collected information including the title of the first content, publisher and current page number. Thereby, the user may examine whether reading information for the first content providing object 11 is successfully obtained.

In addition, the display unit 140 may output a screen for connecting to the cloud service apparatus 300, and a screen for receiving content reading information therefrom and outputting the same. That is, the display unit 140 may provide a menu item or icon enabling the user to obtain second content reading information for locating a desired page in the first content providing object 11. When multiple pieces of content are stored, the display unit 140 may output a content list and display a screen for connecting to the cloud service apparatus 300 to receive reading information for selected content. When content reading information is received from the cloud service apparatus 300, the display unit 140 may output the received content reading information in relation to the content selected by the user. Hence, the user may readily identify a desired reading place to start reading in the first content providing object 11.

The storage unit 150 may store an information collection program 151 to obtain reading information of the first content providing object 11. The information collection program 151 may include a routine for displaying a content list received from the cloud service apparatus 300, and a routine for collecting and outputting reading information of content selected from the content list. The information collection program 151 may include routines for collecting and outputting first content reading information of the first content providing object 11. For example, the information collection program 151 may include a routine for manipulating a camera module, a routine for extracting page information from a captured image of the first content providing object 11, a routine for extracting publisher and title information from a captured image thereof, and a routine for obtaining publisher and title information of the first content providing object 11 through an input means. The information collection program 151 may include a routine for generating first content reading information containing page, publisher and title information, and a routine for sending the first content reading information to the cloud service apparatus 300.

Reading information 153 may include first content reading information and second content reading information. The first content reading information is related to the first content providing object 11 and the second content reading information is information received from the cloud service apparatus 300. As described above, the first content and the second content have the same payload with different reading modes. For example, the first content may be a paper book and the second content may be an electronic book having the same contents as the paper book. The first content reading information and the second content reading information may include title, publisher and page information. The page information may indicate the last reading place in the corresponding content or a user-specified page therein.

The information collector 170 may be configured to obtain reading information of the first content providing object 11 such as page, publisher, tile, author and book size information. The information collector 170 may be realized in various forms according to how reading information (e.g., book information) is attached to the first content providing object 11. For example, when such reading information is represented as a bar code or Quick Response (QR) code, the information collector 170 may include a scanner module or camera module capable of recognizing such bar code or QR code. When a marker recognizing pages of the first content providing object 11 is provided, the information collector 170 may include a marker recognition panel for recognizing such marker. When the first content providing object 11 emits sensor signals, the information collector 170 may include a sensor signal recognizer capable of obtaining information related to the first content providing object 11 such as author, publisher, title or book size information by sensing the sensor signals. The information collector 170 may be composed of a keypad or key buttons for entering publisher, title or other information. In this case, the display unit 140 having a touchscreen capability or the input unit 120 may serve as the information collector 170. That is, although shown as a separate constituent, the information collector 170 may be replaced with the display unit 140 or the input unit 120.

The control unit 160 may control signal exchange and data transfer for operation of the first terminal 100. In particular, in response to an input signal requesting second content reading information related to the first content providing object 11, the control unit 160 may control an operation to connect to the cloud service apparatus 300, to receive second content reading information related to the first content providing object 11 therefrom, and to output the received second content reading information on the display unit 140. To this end, the control unit 160 may control the display unit 140 to output a list of first content providing objects 11 having second content reading information or a list of second content reading information together with titles identifying individual list entries. When the user selects specific content from the list, the control unit 160 may collect second content reading information related to the selected content. Here, the second content reading information includes information on the last read page. Hence, information on a page of the first content providing object 11 to be read can be provided to the user.

When a reading aid for the first content is provided to the first content providing object 11, the first terminal 100 may automatically output second content reading information corresponding to a page of the first content providing object 11 to read. For example, the first content providing object 11 may be assumed to include an illuminance sensor or pressure sensor for sensing opening and closing thereof and to send a sensor signal to the first terminal 100. In this case, when the user manipulates the first content providing object 11 for reading, the first content providing object 11 may send a corresponding sensor signal to the first terminal 100, which may then control the display unit 140 to automatically display second content reading information. Here, the sensor signal sent by the first content providing object 11 to the first terminal 100 may include identification information of the first content providing object 11. Hence, the first terminal 100 may identify the first content providing object 11 by analyzing a sensor signal received from the first content providing object 11 and output second content reading information correspondingly. To achieve this, identification information of each sensor attached on the first content providing object 11 may be registered in the first terminal 100 in advance.

The control unit 160 may use the information collector 170 to collect information on the first content providing object 11 such as page, publisher and title information and generate first content reading information on the basis of the collected information. Specifically, the control unit 160 may control the information collector 170 to capture an image of a specific page of the first content providing object 11 and extract page information from the captured image. The control unit 160 may control the information collector 170 to collect reading information through recognition of code information attached to the first content providing object 11 and generate first content reading information on the basis of the collected information. The control unit 160 may generate first content reading information on the basis of information entered through the input unit 120 and the display unit 140 serving as an input means. The control unit 160 may send the generated first content reading information to the cloud service apparatus 300.

In the event that the first content providing object 11 has a sensor sensing opening and closing thereof, when the first content providing object 11 is closed, it may send a corresponding sensor signal and current page information to the first terminal 100. To obtain current page information, a camera may be provided for the first content providing object 11. When a page of the first content providing object 11 is turned, the camera may capture an image of the opposite page and send the captured image as current page information to the first terminal 100. The first terminal 100 may identify publisher, title and author information of the first content providing object 11 from received sensor signals, generate first content reading information using the identified information, and send the first content reading information.

As described above, when the user finishes reading the first content providing object 11, the first terminal 100 obtains current page information of the first content providing object 11 and enables the second terminal 200 to utilize the current page information. Also, when the user starts to read the first content providing object 11, the first terminal 100 enables the user to refer to reading information of the second content played back on the second terminal 200.

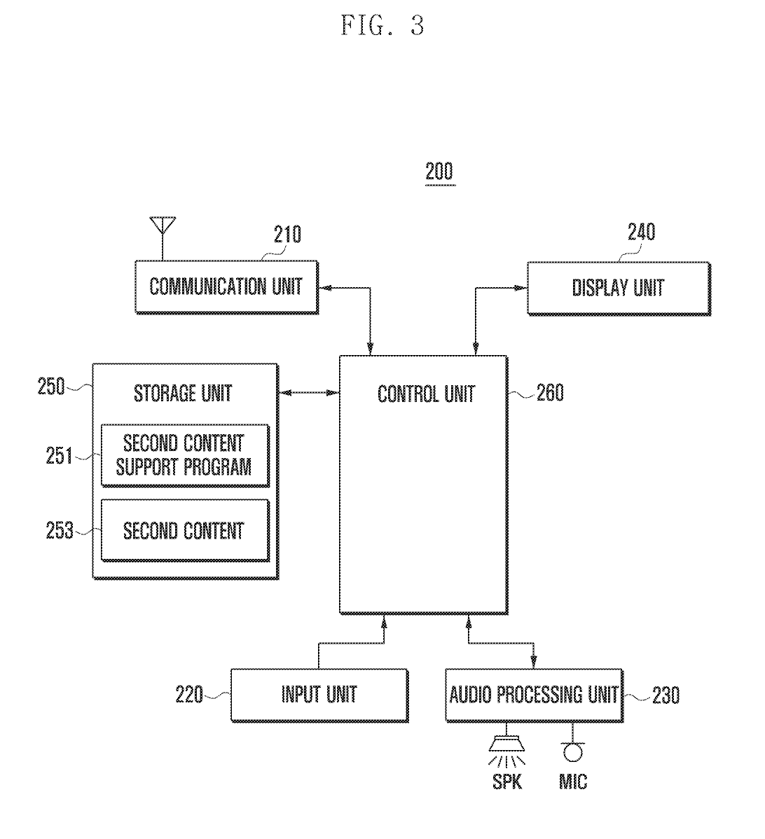

FIG. 3 is a block diagram of the second terminal according to an embodiment of the present disclosure.

Referring to FIG. 3, the second terminal 200 may include a communication unit 210, an input unit 220, an audio processing unit 230, a display unit 240, a storage unit 250, and a control unit 260.

The second terminal 200 having the above configuration may play back second content 253 that is the same in payload as the first content providing object 11 but is different in a reading mode therefrom. In response to a playback request for the second content 253, which has an option to use content reading information, the second terminal 200 may receive first content reading information from the cloud service apparatus 300, determine the playback position of the second content 253 using the received information, and play back the second content 253 from the determined playback position.

Specifically, the communication unit 210 supports communication of the second terminal 200. In particular, the communication unit 210 may automatically establish a communication channel to the cloud service apparatus 300 in response to a user request or playback request for the second content 253. The communication unit 210 may send information on the second content 253 such as title, publisher, author and book size information to the cloud service apparatus 300. The communication unit 210 may receive content reading information and forward the same to the control unit 260.

The input unit 220 may generate various input signals used for operation of the second terminal 200. For example, the input unit 220 may generate an input signal for outputting a list of content stored in the storage unit 250, an input signal for selecting specific content (e.g., the second content 253) from the list, and an input signal for playing back the second content 253 on the basis of content reading information provided by the cloud service apparatus 300. For playback of the second content 253, the input unit 220 may generate an input signal for requesting acquisition of page information of a first content providing object 11 which is the same in payload as the second content 253 but is different in a reading mode, an input signal for connecting to the cloud service apparatus 300 to obtain page information, and an input signal for determining whether to apply the obtained page information to playback of the second content 253. To this end, the second terminal 200 may output a series of screens containing various virtual buttons to generate such input signals during playback of the second content 253. The generated input signals may be sent to the control unit 260. The input unit 220 may be realized using key buttons or a keypad. When the display unit 240 has a touchscreen capability, the input unit 220 may be realized using a key map on a touchscreen.

The audio processing unit 230 supports output of various audio data in the course of operating the second terminal 200. When the second terminal 200 supports communication or recording, the audio processing unit 230 may include a microphone MIC to collect audio data. When the second content 253 that is of audio type or contains audio data is selected for playback, the audio processing unit 230 may output audio data related to the second content 253. In particular, the audio processing unit 230 may output a sound notification indicating reception of content reading information from the cloud service apparatus 300.

The display unit 240 may display a variety of screens used for operation of the second terminal 200, such as an idle screen, menu screen and icon screen. In particular, in response to an activation request for the second content 253 stored in the storage unit 250, the display unit 240 may display a screen for the second content 253. Here, the display unit 240 may display a screen for selecting second content 253 among a plurality of content. The display unit 240 may display a screen for receiving content reading information from the cloud service apparatus 300. The display unit 240 may display the received content reading information to the user. Operations of the display unit 240 are described in more detail later with reference to the drawings.

The storage unit 250 may store a second content support program 251 for playback of the second content 253. When the second content 253 is e-book content, the second content support program 251 may be a playback support program for an e-book. The second content support program 251 may include a routine for presenting a list of content stored in the storage unit 250, a routine for checking whether content selected as the second content 253 has an option for using content reading information for playback, and a routine for connecting to the cloud service apparatus 300 and receiving content reading information for playback of the second content 253 from the cloud service apparatus 300. The second content support program 251 may identify information on the reading place from the content reading information, determine the initial playback position for the second content 253 on the basis of the reading place information, and play back the second content 253 from the initial playback position to output playback results on the display unit 240. The second content support program 251 may support playback of different types of content according to the type of the second content 253 such as audio book content or photo album content.

The control unit 260 may control content coordination operation of the present disclosure using the second content support program 251 stored in the storage unit 250. That is, in response to a playback request for the second content 253, the control unit 260 may send a request for content reading information to the cloud service apparatus 300 and determine the initial playback position of the second content 253 on the basis of the received content reading information. Thereafter, the control unit 260 may control an operation to play back the second content 253 from the initial playback position and to display playback results on the display unit 240.

More specifically, according to selection of a menu item, reception of an input signal or activation of scheduling information requesting playback of the second content 253, the control unit 260 may check whether the second content 253 has an option for using content reading information provided by the cloud service apparatus 300. When the second content 253 has no option for using content reading information, the control unit 260 may control an operation to activate the second content 253 and to play back the second content 253 from a preset page (e.g., page 1). To this end, the second terminal 200 may provide a setting screen for setting start playback pages for a variety of stored content on the basis of content reading information provided by the cloud service apparatus 300. The user may set an option for using content reading information to determine a start playback page for specific content through the setting screen. For effective utilization of content reading information, it is preferable for the user to possess both a first content providing object 11 and second content 253. However, the present disclosure is not limited thereto. For example, a different user may generate first content reading information using information on a specific page of the first content providing object 11 and send the first content reading information to the second terminal 200 through the cloud service apparatus 300.

In response to a playback request for the second content 253, the control unit 260 may request the user to decide whether to receive content reading information from the cloud service apparatus 300. Then, the user may decide whether to connect to the cloud service apparatus 300 by checking whether the wireless environment is sufficient for access to the cloud service apparatus 300 or checking a need for using separate content reading information. Alternatively, when the second content 253 has an option to utilize content reading information for playback, the control unit 260 may connect to the cloud service apparatus 300 by default in response to an activation request for the second content 253. In response to a connection request, the control unit 260 may perform an authentication procedure with the cloud service apparatus 300 and send information on the second content 253 to the cloud service apparatus 300. When content reading information for playback of the second content 253 is received from the cloud service apparatus 300, the control unit 260 may output a notification message indicating reception of content reading information. The control unit 260 may request the user to determine the playback position to start playback of the second content 253 on the basis of the content reading information. When the user requests playback based on the content reading information, the control unit 260 may play back the second content 253 from a page indicated by the content reading information.

In response to generation of an event for terminating playback of the second content 253 such as an input signal for turning the second terminal 200 off or termination of content playback, the control unit 260 may obtain information on the last playback page of the second content 253, generate second content reading information containing information on at least one of the last playback page, publisher, author, title and book size of the second content 253, and send the second content reading information to the cloud service apparatus 300. The second content reading information sent to the cloud service apparatus 300 may be output to the first terminal 100 when the user attempts to read the first content providing object 11. Hence, with reference to the second content reading information, the user may read the first content providing object 11 from a desired page.

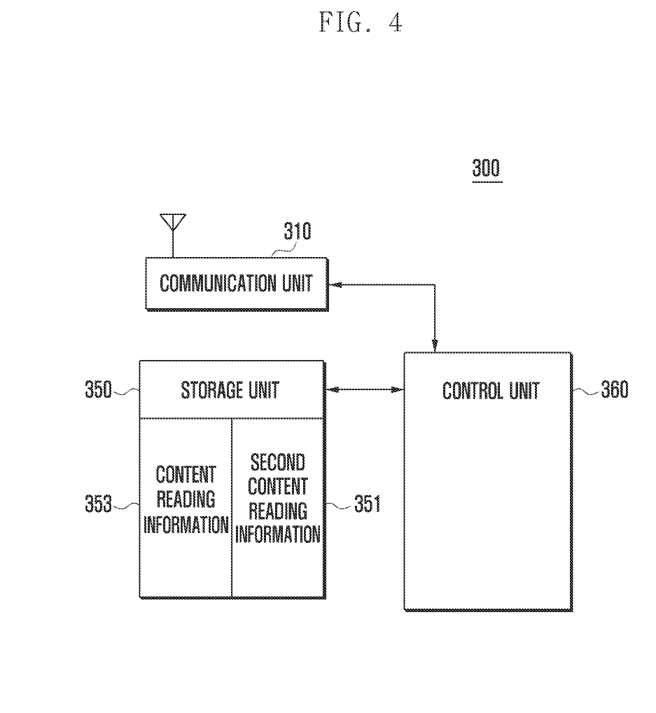

FIG. 4 is a block diagram of the cloud service apparatus according to an embodiment of the present disclosure.

Referring to FIG. 4, the cloud service apparatus 300 may include a communication unit 310, a storage unit 350, and a control unit 360.

The communication unit 310 may be configured to establish a communication channel that is used by the first terminal 100 and second terminal 200 to connect to the cloud service apparatus 300. The communication unit 310 may establish a communication channel through the communication network 400 to enable the first terminal 100 and second terminal 200 to communicate with each other. The communication unit 310 may receive first content reading information from the first terminal 100 and send second content reading information to the first terminal 100 upon request. The communication unit 310 may receive second content reading information from the second terminal 200 and send content reading information 353 generated based on first content reading information to the second terminal 200 upon request.

The storage unit 350 may store second content reading information 351 to be delivered to the first terminal 100. The second content reading information 351 may contain information on at least one of the title, publisher and author of specific content requested by the first terminal 100 and page information thereof. The storage unit 350 may store content reading information 353 to be delivered to the second terminal 200. Here, the content reading information 353 may contain information on at least one of the title, publisher, author and book size of specific content, which has an option to use reading information according to settings of the second terminal 200, and information on the start playback page thereof The content reading information 353 and second content reading information 351 stored in the storage unit 350 may be updated when a playback or reading history of the first content providing object 11 or second content 253 is changed.

The control unit 360 controls operation of the cloud service apparatus 300. In particular, the control unit 360 may support access from the first terminal 100 or the second terminal 200 and perform authentication therefor. In response to a request for the second content reading information 351 from the first terminal 100 for reading of the first content providing object 11, the control unit 360 may find second content reading information 351 corresponding to the first content providing object 11 from the storage unit 350 and send the second content reading information 351 to the first terminal 100.

In response to a request for the content reading information 353 from the second terminal 200 for playback of the second content 253, the control unit 360 may find content reading information 353 corresponding to the second content 253 from the storage unit 350 and send the content reading information 353 to the second terminal 200. Here, the content reading information 353 may be composed so as to be applicable to determination of the playback position of the second content 253 (such as an e-book) using first content reading information.

The control unit 360 may resolve page differences. For example, an e-book corresponding to the second content 253 and a paper book corresponding to the first content providing object 11 may have the same contents but different page layouts. In this respect, the control unit 360 may receive information on a sentence or paragraph of the last read page as part of first content reading information from the first terminal 100. The control unit 360 may locate a page of the second content 253 matching details of the sentence or paragraph extracted from the first content reading information through comparison. Hence, in response to a request for the content reading information 353 from the second terminal 200 for playback of the second content 253, the control unit 360 may send information on the actual page of the second content 253 to the second terminal 200. In addition, the control unit 360 may provide the second terminal 200 with guide information indicating a mismatch between pages of the first content providing object 11 and the second content 253.

Likewise, the control unit 360 may receive information on a sentence or paragraph of the last played page as part of second content reading information 351 and send information on the sentence or paragraph to the first terminal 100. When the first content providing object 11 is manipulated for reading or a user request is issued, the first terminal 100 may output both the page information of the second content reading information 351 and the sentence or paragraph of the page. Accordingly, the cloud service apparatus 300 enables proper page location in the presence of a mismatch between pages of an e-book and paper book.

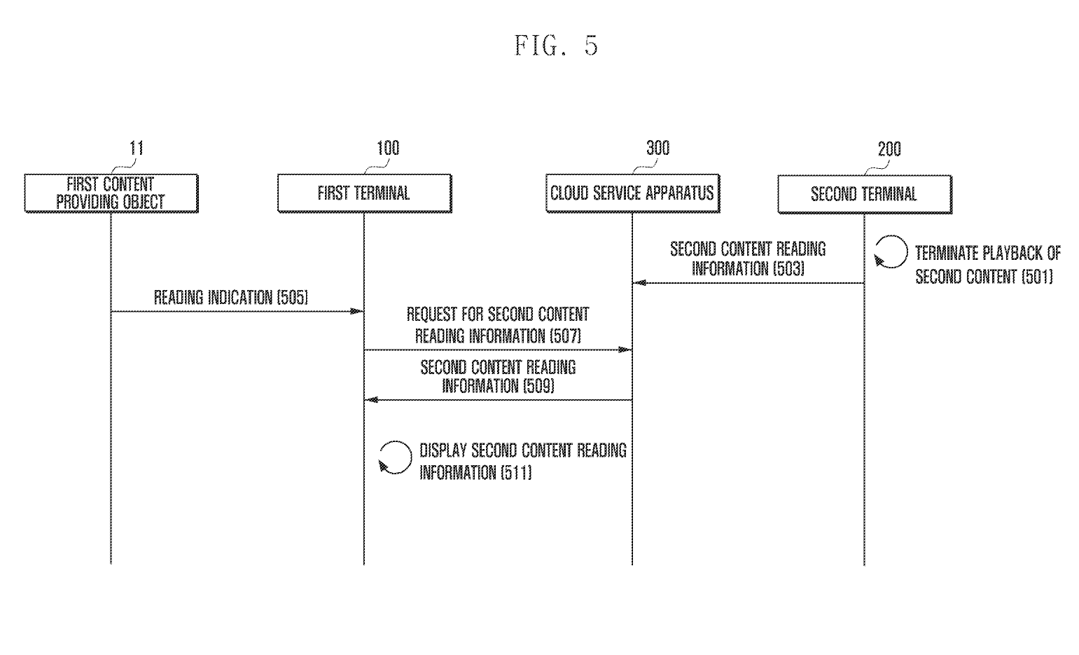

FIG. 5 illustrates signal flows between system constituents implementing a content coordination method according to a first embodiment of the present disclosure.

Referring to FIG. 5, the second terminal 200 may terminate playback of the second content 253 according to a user request, independently of the first terminal 100 at operation 501. The second terminal 200 obtains information on the last played page of the second content 253 and generates second content reading information 351 containing at least one of information on the last played page and information related to the second content 253 such as publisher, author, title and book size. The second terminal 200 sends the second content reading information 351 to the cloud service apparatus 300 at operation 503. To this end, the second terminal 200 may be designed to automatically collect information on the last played page when playback of the second content 253 is ended.

When the user manipulates the first content providing object 11 for reading, the first content providing object 11 may send a sensor signal indicating a user action for reading to the first terminal 100. Alternatively, the user may manipulate the first terminal 100 to directly generate an input signal for checking second content reading information 351 related to the first content providing object 11 (as an indication to a user action for reading of the first content providing object 11). As a result, the first terminal 100 receives an indication to a user action for reading of the first content providing object 11 at operation 505.

Upon reception of an indication of a user action for reading of the first content providing object 11, the first terminal 100 sends a request for second content reading information 351 related to the first content providing object 11 to the cloud service apparatus 300 at operation 507. Upon reception of the request for the second content reading information 351 from the first terminal 100, the cloud service apparatus 300 performs user authentication for the first terminal 100, and sends second content reading information 351 to the first terminal 100 when user authentication is successful at operation 509. Here, the second content reading information 351 may include information on the last played page of the second content 253.

Upon reception of the second content reading information 351 from the cloud service apparatus 300, the first terminal 100 displays page information extracted from the second content reading information 351 on the display unit 140 at operation 511. In addition, the first terminal 100 may display title, publisher and author information extracted from the second content reading information 351 and display a number of sentences or a paragraph of the second content 253 as part of page information.

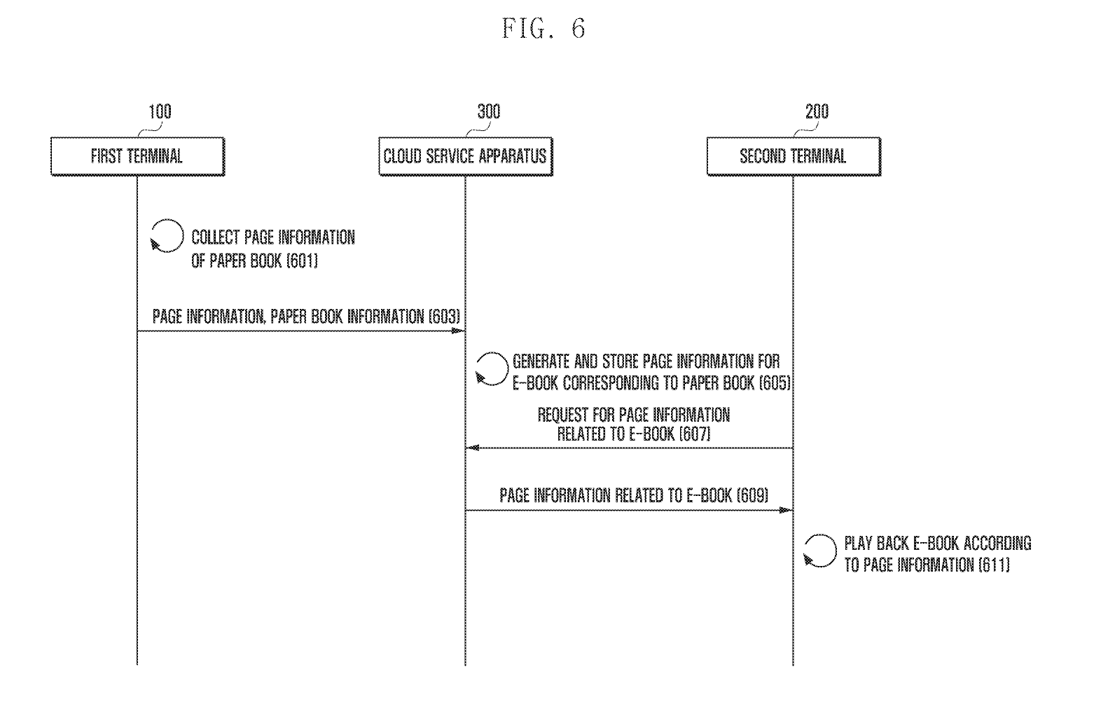

FIG. 6 illustrates signal flows between system constituents implementing a content coordination method according to a second embodiment of the present disclosure. In the following description, the first content providing object 11 is assumed to be a paper book containing specific information, and the second content 253 is assumed to be an e-book that has the same contents as the first content providing object 11 and is electronically playable.

Referring to FIG. 6, in response to a user event indicating termination of reading of a paper book, the first terminal 100 collects information on the last read page of the paper book at operation 601. Here, the first terminal 100 may use the information collector 170 composed of a camera module to obtain information on a page of the paper book at the time of termination of reading. Information on a specific page of the paper book may be collected by recognizing a page marker on the paper book using a touch panel or the like.

Here, a bookmark having a touch panel may be utilized. When the bookmark is brought into contact with a marker of the paper book, the bookmark may collect information on the last read page of the paper book and send the collected information to the first terminal 100. To this end, the bookmark may further include a wireless signal emitter and the first terminal 100 may further include a communication module capable of receiving a signal from the wireless signal emitter of the bookmark. After collection of the page information, the first terminal 100 sends first content reading information containing the page information of the paper book and information thereof to the cloud service apparatus 300 at operation 603. When an illuminance sensor or pressure sensor is provided to the paper book, information on the paper book may be obtained through signals of the sensor. Each sensor signal may carry identifiable information. The first terminal 100 may pre-store information on paper books such as publishers, titles, and authors, which may be carried by sensor signals.

Upon reception of the first content reading information containing page information and paper book information, the cloud service apparatus 300 generates and stores e-book page information corresponding to the first content reading information at operation 605. That is, the cloud service apparatus 300 generates content reading information 353 for the second content 253. The content reading information 353 may be used to locate the start playback page of the e-book.

The second terminal 200 may receive an input signal requesting e-book playback. Here, the second terminal 200 may store one or more e-books and display a list of e-books for selection on the display unit. In response to selection of an e-book to be played back, the second terminal 200 sends a request for content reading information 353 related to the selected e-book at operation 607. Upon reception of the request for e-book content reading information from the second terminal 200, the cloud service apparatus 300 performs user authentication for the second terminal 200, and sends e-book content reading information 353 reflecting page information of the corresponding paper book to the second terminal 200 when user authentication is successful at operation 609.

The second terminal 200 determines the playback position for the e-book on the basis of the received content reading information 353 and plays back the e-book from the playback position so as to display an e-book page corresponding to the playback position at operation 611.

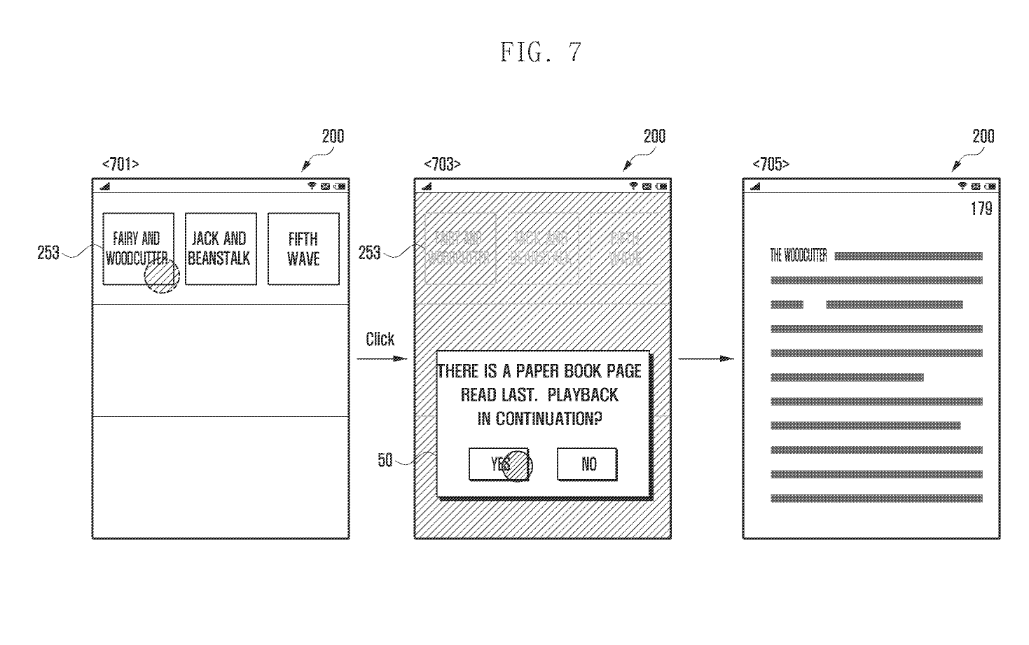

FIG. 7 is screen representations illustrating content coordination in the second terminal according to an embodiment of the present disclosure.

Referring to FIG. 7, the second terminal 200 may output a screen enabling the user to select one of multiple e-books as indicated by reference numeral 701. Here, the second terminal 200 may display a content list so that content with an option to use content reading information is distinguished from content without an option to use content reading information. When the user selects second content 253 (e-book) having an option to use content reading information from the screen, the second terminal 200 may connect to the second terminal 200 and send a request for content reading information related to the second content 253. In this process, the second terminal 200 may perform user authentication according to a request from the cloud service apparatus 300 and send information on the second content 253 to the cloud service apparatus 300. Upon reception of content reading information related to the second content 253, the second terminal 200 may output a notification window 50 requesting the user to decide whether to play back the second content 253 from a position corresponding to the last reading place in the paper book as indicated by reference numeral 703. When the user selects “Yes” for continued playback, the second terminal 200 may display a page of the second content 253 indicated by a playback position corresponding to the last reading place in the paper book as indicated by reference numeral 705.

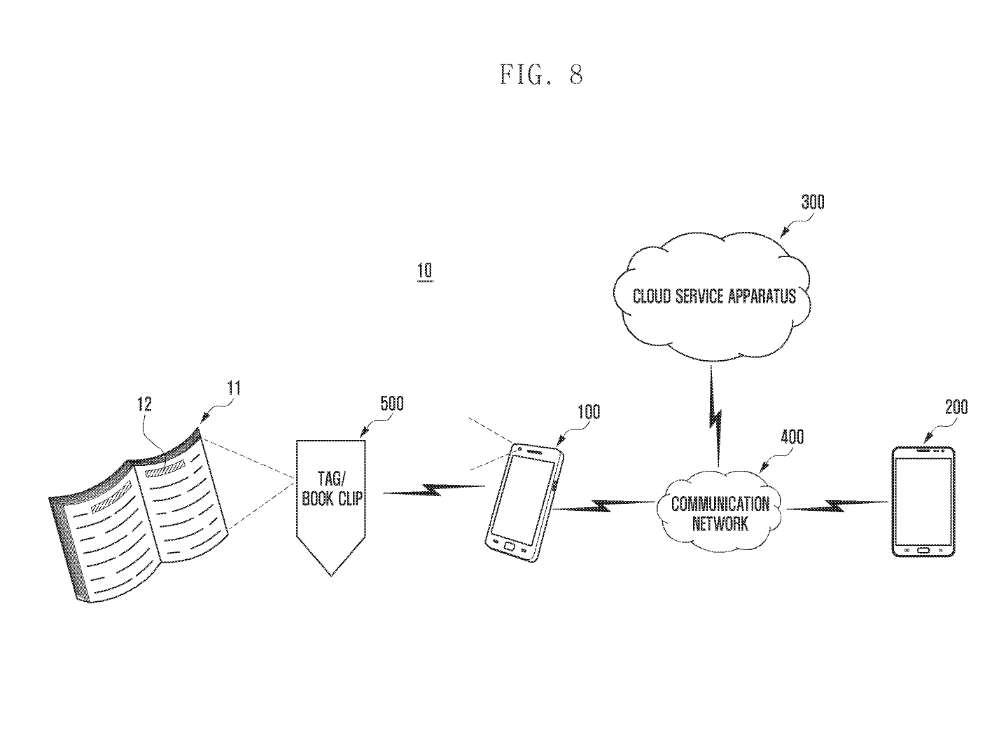

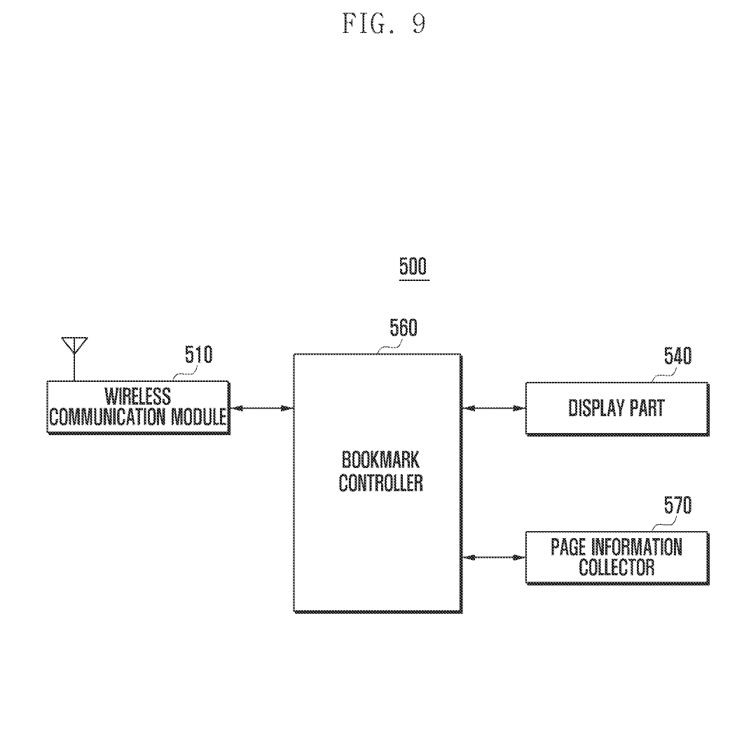

FIG. 8 illustrates a system coordinating paper-book content and e-book content using a bookmark according to another embodiment of the present disclosure, and FIG. 9 is a block diagram of the bookmark. Here, the bookmark is an electronic bookmark capable of emitting signals.

Referring to FIGS. 8 and 9, the content coordination system 10 includes a first content providing object 11, a first terminal 100, a second terminal 200 and a cloud service apparatus 300, and may further include a communication network 400 to exchange signals between the above entities.

In the content coordination system 10 having the above configuration, an electronic bookmark 500 may be placed at a specific reading place at the first content providing object 11. The electronic bookmark 500 may obtain information on the current page of the first content providing object 11 during manipulation of the first content providing object 11 for reading, and send the current page information to the first terminal 100. The first terminal 100 may forward the page information of the first content providing object 11 equipped with the electronic bookmark 500 to the cloud service apparatus 300. Hence, when the first terminal 100 attempts to play back an e-book, the content coordination system 10 enables the first terminal 100 to play back the e-book from a page corresponding to a page of the first content providing object 11 at which the electronic bookmark 500 is placed.

To achieve this, as shown in FIG. 9, the electronic bookmark 500 includes a wireless communication module 510, a page information collector 570 and a controller 560, and may further include a display part 540 according to the design of the electronic bookmark 500.

The page information collector 570 attached to a portion of the electronic bookmark 500 collects page information of the first content providing object 11. The page information collector 570 may recognize a marker 12 attached at a portion of the first content providing object 11 to obtain current page information. The page information collector 570 may include a camera module as in the case of the first terminal 100. In this case, the page information collector 570 may capture an image of a portion of the first content providing object 11 where page information is printed in response to closing of the first content providing object 11 detected by an illuminance sensor or pressure sensor, and send the captured image to the controller 560. To this end, the page information collector 570 may further include an illuminance sensor or pressure sensor. When the first content providing object 11 (e.g., paper book) is opened for reading, the page information collector 570 may detect opening of thereof through the illuminance sensor or pressure sensor and send a sensor signal indicating paper book opening to the controller 560.

For page information collection, markers 12 corresponding to paper-book page information may be provided at portions of the first content providing object 11 where the electronic bookmark 500 may be placed. Each marker 12 may be designed to send specific information when brought into contact with the page information collector 570 serving as a body of the electronic bookmark 500. For example, the markers 12 may be formed in a braille type, and the page information collector 570 may take a form of a touch panel to read the braille type when brought into contact with a marker 12. Page information may be printed at a portion of each page in the first content providing object 11 so that the electronic bookmark 500 may capture an image of the page information. The page information collector 570 may extract page information from a captured image of printed page information in the first content providing object 11.

The wireless communication module 510 sends page information obtained by the page information collector 570 to the first terminal 100. To this end, the wireless communication module 510 may be one of various communication modules, such as a wireless short-range communication module and a mobile communication module, compatible with a corresponding communication module of the first terminal 100. To support communication with the electronic bookmark 500 (in addition to existing functions described in connection with FIG. 1), the first terminal 100 may further include a wireless communication module compatible with the wireless communication module 510 for communication channel establishment. For example, when the wireless communication module 510 operates in a radio frequency band, the wireless communication module of the first terminal 100 may operate in the same radio frequency band for signal processing.

Alternatively, when the wireless communication module 510 is capable of connecting to the cloud service apparatus 300, the first terminal 100 may be omitted from the content coordination system 10. That is, in the content coordination system 10 of FIG. 1, the first terminal 100 may be replaced with the electronic bookmark 500. In this regard, the wireless communication module 510 may be one of various communication modules such as a Wi-Fi communication module capable of accessing a wireless access point and a mobile communication module capable of accessing the cloud service apparatus 300 through a mobile communication network. It is preferable for the electronic bookmark 500 to have a simple structure, and thus the wireless communication module 510 may be configured based on wireless local area communication.

The display part 540 may output various information related to the electronic bookmark 500. For example, the display part 540 may display remaining battery power of the electronic bookmark 500, states of page information collection and transmission, and information on the last read page of an e-book. The display part 540 may have a simple configuration according to characteristics of the electronic bookmark 500. For example, the display part 540 may be realized using a single line Light Emitting Diode (LED) display. For more versatile information output, the display part 540 may be realized as an LED or Organic LED (OLED) display. The display part 540 may be configured to output a variety of information under the control of the controller 560.

The controller 560 may perform various control operations for the electronic bookmark 500. For example, the controller 560 may check remaining power of a battery serving as a power source and control the display part 540 to output the remaining battery power. When the remaining battery power is below a preset threshold value, the controller 560 may control the display part 540 to output a notification message or blinking effect indicating a need to charge the battery.

When the electronic bookmark 500 is placed at a portion of the first content providing object 11 to thereby generate pressure due to contact, the controller 560 controls the page information collector 570 to obtain page information. To this end, the controller 560 may supply power to the pressure sensor or the like and check for generation of pressure. When page information is obtained through contact with a marker 12, the controller 560 may control an operation to send the page information directly or through the first terminal 100 to the cloud service apparatus 300.

When opening of the first content providing object 11 is detected through the pressure sensor sensing a pressure change, the controller 560 sends a request for last playback page information of the e-book to the first terminal 100. The first terminal 100 receives last playback page information of the e-book from the cloud service apparatus 300 and forwards the same to the electronic bookmark 500. Upon reception of the last playback page information of the e-book from the first terminal 100, the controller 560 outputs the last playback page information of the e-book on the display part 540. Hence, the user may easily determine the page of the first content providing object 11 to read with reference to the last playback page information of the e-book having the same contents as the first content providing object 11.

The above description is centered on documents such as a paper book and an e-book having the same contents. However, the present disclosure is not limited thereto. For example, the present disclosure may also be applied to a situation where different moving images having the same contents but different formats are played back by different terminals. Terminals having different screen sizes and different hardware characteristics may employ different moving image players and use different codecs even for the same moving image. In this case, the cloud service apparatus 300 may support sharing of last playback information of moving images among different terminals. Hence, assuming that first and second moving images have the same contents but different formats, when a user attempts to play back the first moving image using a first terminal, the user may play back the first moving image from a position corresponding to a position in the second moving image where the user terminated last playback with a second terminal. Here, the last playback information may include an element identifying a specific position in a moving image such as elapsed time or caption.

Although the above description is centered on different types of content, collection and sharing of last playback information may also be applied to content of the same type.

As described hereinabove, the content coordination system of the present disclosure enables a first terminal wishing to play back first content to use information on a position in second content related to the first content where playback of the second content by a second terminal is terminated last. Hence, when a user wishes to resume playback of content from a previous position, the present disclosure enables the user to easily locate a desired playback position between different versions of content.

The terminal of the present disclosure may further include various components according to a design of the terminal. That is, when the terminal supports communication, although not shown, the terminal may further include a local area communication module for local area communication, a data communication interface based on wired and wireless communication, an Internet communication module for Internet access, and a digital broadcast reception module for playing digital broadcasts. Although possible variations are too numerous to enumerate given the pace of digital convergence, it should be apparent to those skilled in the art that the terminal may further include a unit comparable to the above-described units, and one unit of the terminal may be removed or replaced with another unit.

The terminal of the present disclosure may be any information and communication appliance or multimedia appliance, such as a mobile communication terminal based on communication protocols supporting various communication systems, a Portable Multimedia Player (PMP), a digital broadcast receiver, a Personal Digital Assistant (PDA), a digital music player, a portable game console, a smartphone, a laptop computer, or a handheld computer.

While the present disclosure has been shown and described with reference to various embodiments, it will be understood by those skilled in the art that various changes in form and details may be made therein without departing from the spirit and scope of the present disclosure as defined by the appended claims and their equivalents.

What is claimed is:

1. A system for content coordination, the system comprising:
a first terminal obtaining information on a specific page of a content providing object and sending information on the content providing object and the page information thereof;
a cloud service apparatus generating content reading information for second content, which is the same in payload as the content providing object but is different in a reading mode therefrom, using the information on the content providing object and the page information thereof; and
a second terminal supporting content playback, and playing back, in response to a playback request for the second content, the second content from a page indicated by the content reading information.

2. The system of claim 1, wherein the content providing object is a paper book with printed information and the second content is an e-book having the same contents as the paper book, and
wherein the system further comprises an electronic bookmark, placed in the content providing object, recognizing a marker on a page of the content providing object to obtain information on the page and sending the page information to the first terminal.

3. A service apparatus supporting content coordination, the service apparatus comprising:
a communication unit receiving first content reading information containing information on a content providing object and information on a page thereof, and receiving second content reading information containing information on second content, which is the same in payload as the content providing object but is different in a reading or a playback mode therefrom, and information on a last playback page thereof; and
a control unit controlling a process of sending the first content reading information to a second terminal playing back the second content and sending the information on the second content to a first terminal obtaining information on a page of the content providing object.

4. The service apparatus of claim 3, wherein the information on the content providing object and the information on the second content comprise at least one of publisher information, author information, title information, book size information, one or more sentences of a page, and a paragraph of the page.

5. The service apparatus of claim 3, wherein the control unit converts the first content reading information into content reading information applicable to the second content and sends the content reading information to the second terminal.

6. A terminal supporting content coordination, the terminal comprising:
an information collector obtaining information on a content providing object and information on a page thereof;
a control unit controlling a process of generating first content reading information containing information on the content providing object and information on a page thereof, and sending the first content reading information to a cloud service apparatus; and
a communication unit supporting transmission of the first content reading information.

7. The terminal of claim 6, wherein the information collector comprises at least one of:
a camera module to capture an image of a page of the content providing object;
a sensor signal receiver to receive a sensor signal from a sensor detecting opening and closing of the content providing object;
one of a code recognizer and camera module to recognize codes assigned to pages of the content providing object; and
a marker recognition panel to recognize a marker placed at the content providing object for page recognition.

8. The terminal of claim 6, wherein the communication unit receives second content reading information containing information on a last playback page of second content, which is the same in payload as the content providing object but is different in a reading or a playback mode therefrom.

9. The terminal of claim 8, further comprising a display unit displaying the received second content reading information.

10. The terminal of claim 6, wherein the first content reading information comprises page information obtained from a page of the content providing object and at least one of publisher information, author information, title information, book size information, one or more sentences of the page, and a paragraph of the page of the content providing object.

11. A terminal supporting content coordination, the terminal comprising:
a display unit outputting a screen for playback of an e-book;
a communication unit receiving, in response to a playback request for the e-book, content reading information of first content, which is the same in payload as the e-book but is different in a reading mode therefrom, from a different terminal; and
a control unit controlling an operation to play back the e-book from a page indicated by page information contained in the content reading information.

12. The terminal of claim 11, wherein the content reading information comprises page information obtained from a page of the first content that is a paper book and at least one of publisher information, author information, title information, book size information, one or more sentences of the page, and a paragraph of the page of the first content.

13. A method for content coordination, the method comprising:
receiving, by a terminal, a reading request for a content providing object that is a paper book;
receiving, by the terminal, information on a last playback page of second content, which is the same in payload as the content providing object but is different in a reading mode therefrom, from a service apparatus; and
outputting, by the terminal, the information on the last playback page.

14. The method of claim 13, wherein the receiving of the reading request comprises at least one of:
receiving a sensor signal from a sensor detecting opening and closing of the content providing object; and
receiving, upon reading of the content providing object, an input signal requesting page information of the second content.

15. The method of claim 13, further comprising:
placing an electronic bookmark at a page of the content providing object;
obtaining, upon page closing in the content providing object, by the electronic bookmark, page information of the content providing object by recognizing a marker placed thereat;
sending, by the electronic bookmark, the page information directly or through the terminal to the cloud service apparatus; and
sending, when a different terminal requests playback of second content which is the same in payload as the content providing object but is different in a reading mode therefrom, the page information of the content providing object to the different terminal.

16. A method for content coordination, the method comprising:
receiving, by a terminal, a playback request for an e-book;
receiving, by the terminal, page information of a content providing object, which is the same in payload as the e-book but is different in a reading mode therefrom, from a service apparatus; and
outputting, by the terminal, information on a playback page of the e-book on the basis of the page information.

17. The method of claim 16, further comprising at least one of:
receiving an input signal for connecting to the service apparatus to receive the page information;
receiving an input signal to apply the page information; and
sending information on the e-book to the service apparatus.

18. The method of claim 16, wherein the content providing object is a paper book with printed information.

19. The method of claim 16, further comprising displaying a list of stored content so that content with an option to use page information is distinguished from content without an option to use page information.

20. The method of claim 16, further comprising:
receiving, by an electronic bookmark, information on the playback page of the e-book from the terminal; and
outputting, by the electronic bookmark, the received information on the playback page of the e-book.
